(19) United States
(12) Patent Application Publication
(10) Pub. No.: US 2016/0346892 A1
(43) Pub. Date: Dec. 1, 2016

(54) USE OF PHOTOGRAMMETRY FOR MACHINING OF PARTS

(71) Applicant: CATERPILLAR INC., Peoria, IL (US)

(72) Inventors: ROHIT BHAPKAR, PEORIA, IL (US); THIMMAIAH KUMBERA, PEORIA, IL (US)

(73) Assignee: CATERPILLAR INC., Peoria, IL (US)

(21) Appl. No.: 14/726,985

(22) Filed: Jun. 1, 2015

(51) Int. Cl. B23Q 17/20; B23Q 17/24; G05B 19/4097; B23Q 15/20; G01C 11/02; G01B 11/04

(52) U.S. Cl. CPC B23Q 17/20; G01C 11/02; G01B 11/04; G05B 19/4097; B23Q 15/20; B23Q 17/2428; G05B 2219/35134

(57) ABSTRACT

A process of manufacturing or remanufacturing a component of an earthmover is provided and includes casting or welding a component that can then be attached to a moveable table and images of the entire component can be captured by an imaging device or a plurality of imaging devices. After the images are captured, the images are stitched or manipulated to form a 2D/3D image of the component. The 2D/3D image or images can then be compared with a database of OEM components to determine the differences (dimensions, surface characteristics, etc.) between the 2D/3D image and an OEM component. Once the differences are determined between the 2D/3D image and the OEM specification, the machining process can be adjusted based on the determined differences. This allows for adjustment to the machining process so that overall machining and measuring cycle times are reduced and proper machining tools are efficiently utilized.

### TECHNICAL FIELD

The disclosure relates to the use of photogrammetry, and more specifically, relating to using photogrammetry on a machine part or component.

### BACKGROUND

Large earthmovers such as mining equipment are used in harsh conditions. These large earthmovers require large components (truck frames, pump housings, track roller frames, wheeled loader upper, etc.) that may be castings or welded structures. The cast components often require machining in order to conform the cast components to the desired specification. Machining processes such as milling, drilling and turning/boring include using power driven machines with cutting tools in order to remove excess material from the cast or welded component. However, dimensional variations in large components lead to issues in production such as tool breakage due to abruptly encountering excess material, or machine tool spindle damage due to the unexpected presence of excessive material. These issues are often mitigated through the use of machine probes. However, the use of machine probes is often time-consuming and the machine probes often break due to their fragile nature.

U.S. Patent Publication No. 2011/0295408 discloses a process for accurately determining a work piece position in relation to a reference coordinate system. The process includes providing a machine having a table and a machine coordinate system, determining locations of three reference geometric aspects of the table, providing a work piece, and attaching the work piece to the table. Thereafter, locations of three geometrical aspects of the work piece are determined using photogrammetry followed by calculation of any offset between the three reference geometrical aspects of the table and the three geometrical aspects of the work piece. Any offset that has been determined can then be used to accurately determine the work piece position in relation to the reference coordinate system. This disclosed process can be time-consuming and collocated as it requires calculations of three reference geometrical aspects of the table and at least three geometrical aspects of the work piece when it is in the first position or the second position.

Thus, there is a need for an improved process that is accurate and reduces the time required to measure and machine a cast or welded component or any component with a lot of geometrical variations.

### SUMMARY

In one aspect, a manufacturing system for a component can include a machining tool configured to machine a large cast or welded component, an imaging device configured to travel on a carriage and capture a plurality of images of the component, wherein the carriage is configured to allow the imaging device to translate on a plurality of axis, a component moving device configured to move the component along the plurality of axis, and a computing device configured to store a software and a database of a plurality of images of an original equipment manufacturer's component, wherein the computing device utilizing the software to perform the steps of receiving the image captured by the imaging device, stitching the plurality of images to form a 2D/3D image of the component, comparing the 2D/3D image with the plurality of images of the original equipment manufacturer's component, and adjusting an operating cycle of the machining tool based on the comparison.

In another aspect, a manufacturing system for a component is provided and includes a machining tool configured to machine a cast or welded component, a plurality of imaging devices configured to travel on a plurality of carriages and to capture a plurality of images of the component, wherein the plurality of carriages are configured to allow the plurality of imaging devices to translate on a plurality of axis, a component moving device configured to move the component along the plurality of axis, and a computing device configured to store a software and a database of plurality of images of an original equipment manufacturer's component, wherein the computing device utilizing the software to perform the steps of receiving the plurality of images captured by the plurality of imaging devices, stitching the plurality of images to form a 2D/3D image of the component, comparing the 2D/3D image with the plurality of images of an original equipment manufacturer's component, determining a difference between the 2D/3D image and the plurality of images of the original equipment manufacturer's component, and creating a new cycle or adjusting a preprogrammed operating cycle of the machining tool based on the determined difference.

### BRIEF DESCRIPTION OF THE DRAWINGS

FIG. 1 illustrates a perspective view of a photogrammetry system according to an aspect of the disclosure.

FIG. 2 illustrates a planar location grid according to an aspect of the disclosure.

FIG. 3 illustrates a schematic diagram of an exemplary process for using photogrammetry to machine a component according to an aspect of the disclosure.

### DETAILED DESCRIPTION

The disclosure provides for the use of photogrammetry to quickly measure the dimensions of cast/weld components and adjusts the machine cycle to reduce a total machining cycle time. The cast component can be created during a manufacturing or remanufacturing process. Another aspect of the disclosure provides for the use of photogrammetry to adaptively adjust the machining cycle to enable the robust machine deburring process with standard catalog tools thereby improving process quality, operator safety, and avoid using dedicated deburring equipment for parts with large variations.

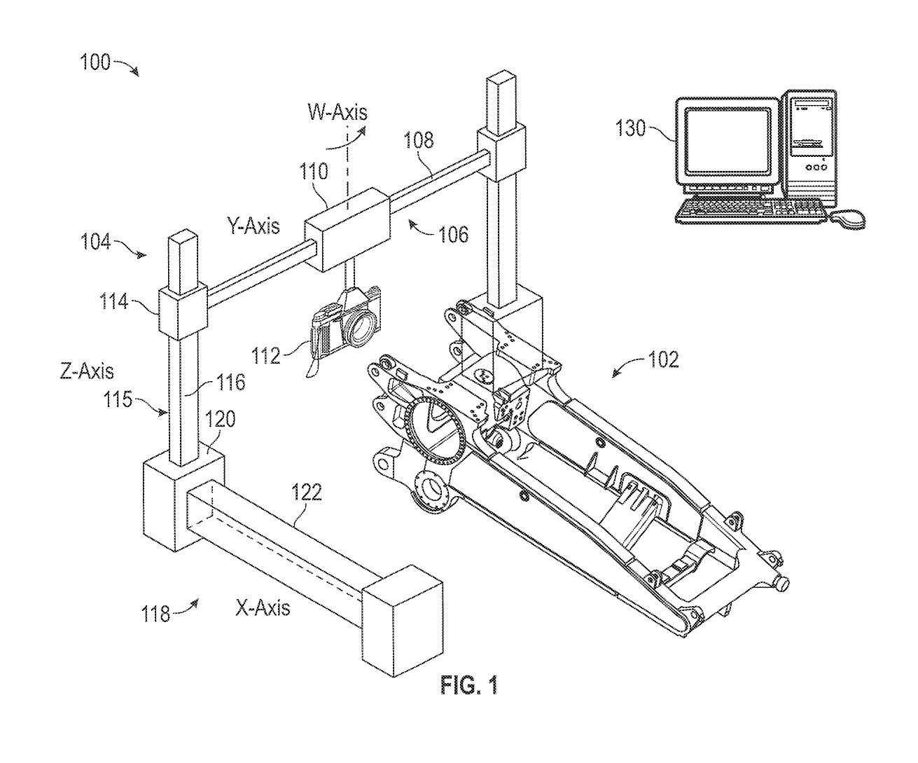

FIG. 1 illustrates a perspective view of a photogrammetry system 100 according to an aspect of the disclosure. A large part or component 102 is provided for scanning and ultimately machining The large component 102 can be manufactured using a cast process such as die casting (aluminum, etc.), sand casting (large steel parts, etc.) or print process such as 2D/3D printing. The large component 102 can be welded to other components of the vehicle such as an earthmoving vehicle or be a self-contained unit component.

The photogrammetry equipment 104 is configured and designed for moving an imaging device 112 or a plurality of imaging devices 112 in various linear and rotary machine axes designated, for example, as the X/Y/Z, U/V/W and A/B/C. The photogrammetry equipment 104 can be attached to supporting devices that are affixed to aforementioned axes and are driven in conjunction with the axis of motion. The axes motion can be driven by means of either mechanized apparatuses such as a motor, or pulley/chain system or alternately, by manual methods.

In one aspect of the disclosure, the photogrammetry equipment 104 includes carriages such as an X axis machine carriage 118, a Y axis machine carriage 106 and a Z axis machine carriage 115. However, in another aspect of the disclosure, other axis machine carriages (U, V, W or A, B, C) can also be utilized depending on the component and desire of a user. The X axis machine carriage 118 can include an X axis translating bar 122 that allows an X-axis carrier 120 to translate along the X axis. The X axis carrier 120 may translate along the X axis translating bar 122 via various mechanized apparatuses such as a motor, or pulley/chain system or the like. The X axis carrier 120's movement may be controlled by a computing device 130 or may be controlled manually as desired by the user. A similar X axis machine carriage 118 (not shown) is also positioned on the opposite side and parallel to the X axis machine carriage 118 that is shown.

The Y axis machine carriage 106 can include a Y axis translating bar 108 that allows a Y-axis carrier 110 to translate along the Y axis. The Y axis carrier 110 can have the image device 112 or a plurality of imaging devices 112 mounted thereto and can rotate the imaging device around the W-axis. The Y axis carrier 110 may translate along the Y axis translating bar 108 via various mechanized apparatuses such as a motor, or pulley/chain system or the like. The Y axis carrier 110's movement may be controlled by a computing device 130 or may be controlled manually as desired by the user.

The imaging device 112 can be any type of imaging device such as digital single lens reflex (DSLR), charge coupled device (CCD), video image device, helmet type image device, 2D/3D imaging device, thermal imaging image device, scanning image device and the like. Depending on the type of imaging device, the imaging device can not only provide surface information but also penetrate below a surface of the component to provide at least some internal information about the component, such as the presence of excess material in the component. The imaging device 112 can also be rotated (W-Axis) or translated along the X, Y, Z and W axis in order to provide a full range of image capturing. The imaging device's movement or when the imaging device 112 captures the image may be controlled by a computing device 130 or may be controlled manually as desired by the user. In an aspect of the disclosure, one or more imaging devices 112 can be placed to translate along the X axis, Y axis, and/or the Z axis.

The Z axis machine carriage 115 can include a Z axis translating bar 116 that allows a Z-axis carrier 114 to translate along the Z axis. The Z axis carrier 114 may translate along the Z axis translating bar 116 via various mechanized apparatuses such as a motor, or pulley/chain system or the like. The Z axis carrier 114's movement may be controlled by a computing device 130 or may be controlled manually as desired by the user. A similar Z axis machine carriage 115 (not shown) is also positioned on the opposite side and parallel to the Z axis machine carriage 115 that is shown.

It should be noted, that any device that allows the imaging device 112 or a plurality of image devices 112 to translate or rotate in the X, Y, Z and W axis can be used. Additionally, the image device 112 can be mounted on a tripod and be manually moved, translated or positioned along the X, Y, Z and W axis.

Although FIG. 1 illustrates that the photogrammetry equipment 104 is configured and designed to move while the component 102 remains stationary. In another aspect of the disclosure, the component 102 may be moved, translated or positioned in the various X, Y, Z and W axis while positioned on a table or a movable work piece and while the imaging device 112 remains stationary. In still another aspect of the disclosure, both the imaging device 112 and the component 102 are movable in relation to each other.

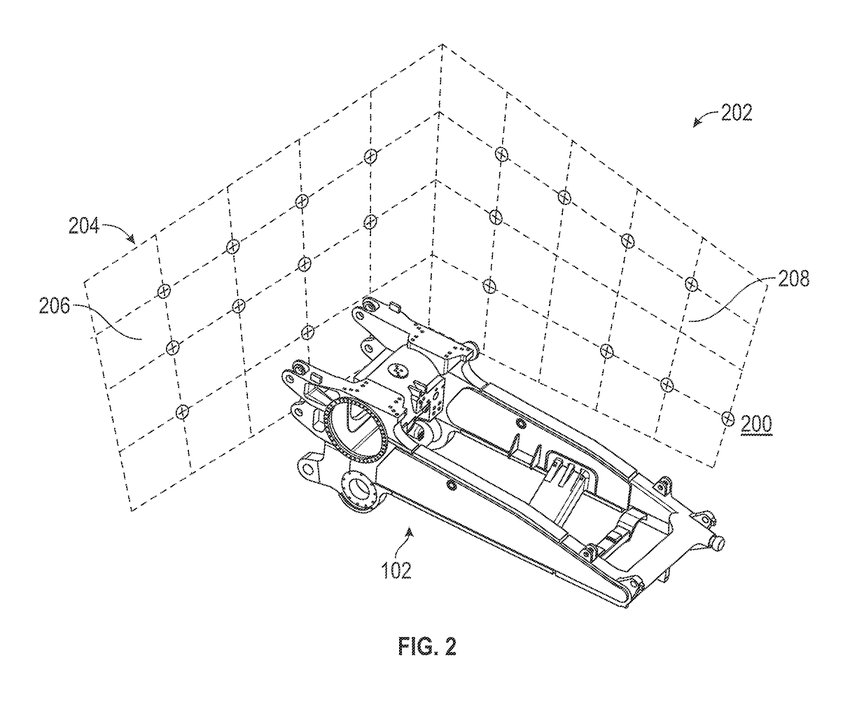

FIG. 2 illustrates a planar location grid 200 according to an aspect of the disclosure. Imaging device 112 is capable of taking images from various angles of the component 102, however, the images are only a portion of the component as the imaging device translates in the X, Y, Z and W axis. Thus, images are manipulated or stitched together in order to form one cohesive 2D/3D image so that software can determine the configuration of the component 102. The planar location grid 200 may include the ZY axis plane grid 204 and the ZX axis plane grid 202. In one aspect of the disclosure, the imaging device 112 may be configured to capture one portion 206 of the ZY axis plane grid 204 at a time as it translates along the Z and Y axis. Similarly, the imaging device 112 may be configured to capture one portion 208 of the ZX axis plane grid 202 at a time as it translates along the Z and X axis. Once the image device 112 completes its rotation, translation or movement along the X, Y, Z and W axis or other axis as needed, a software stored in the computing device 130 can be used to manipulate or stitch the various portions 206, 208 together in order to form one cohesive 2D/3D image of the component for viewing.

It should be noted that although only ZX axis plane grid 202 and ZY axis plane grid 204 are shown, other planes including parallel planes to ZX axis plane grid 202 and ZY axis plane grid 204 are also part of the disclosure. As many axis planes can be used as needed so that the entire component 102 can be captured so that one cohesive 2D/3D image can be formed.

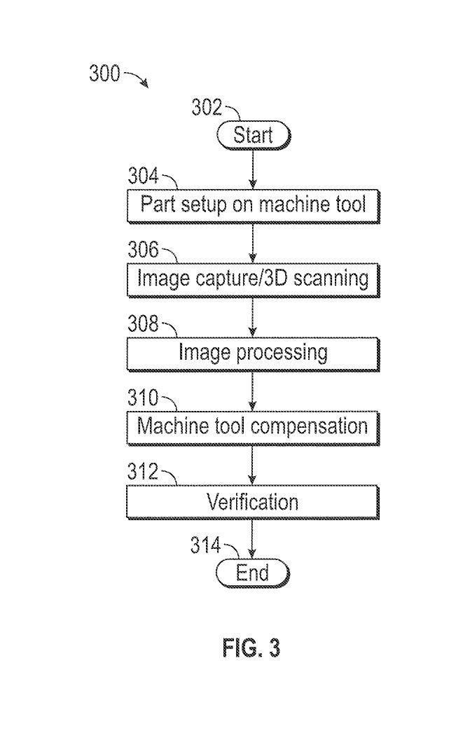

FIG. 3 illustrates a schematic diagram 300 of an exemplary process for use photogrammetry to machine a component according to an aspect of the disclosure. The process can start at step 302 then proceed to step 304 where the part or component 102 is set up on a machining tool. The component 102 may be held in place via various clamps that may be attached to a movable table as previously discussed. The component 102 can be any component of a vehicle, device or apparatus. At step 306, image capture 2D/3D scanning may be completed using the imaging device 112 or a plurality of imaging devices 112. The imaging device 112 can be moved, positioned, rotated or translated along the X, Y, Z and W axis as previously discussed. The imaging device 112 may be configured to capture one portion 206 of the ZY axis plane grid 204 at a time as it translates along the Z and Y axis. Similarly, the imaging device 112 may be configured to capture one portion 208 of the ZX axis plane grid 202 at a time as it translates along the Z and X axis. The captured images may be sent from the imaging device via a wireless (Wi-Fi, cellular, satellite and the like) or a wired connection (USB, serial and the like) to a computing device 130 that may include a processor that processes information and operates a software and memory that stores the software to stitch or manipulate the images so that they form one cohesive 2D/3D image of the component 102. A 2D image of component 102 could also be used.

At step 308, the image may be processed. The images captured by the imaging device 112 may be stitched together by software to create a single, cohesive 2D/3D image of the component 102. Explicit software such as Adobe Photoshop, GIMP, Pixelsoft, and Pixelprofile may be used or alternatively or in addition to, implicit software such as Matlab or Mathematica may be used to stitch or render the 2D/3D image. The images will be sorted mathematically to determine the surface contour error map using surveying techniques such as surface topology mapping to create real time representation of the component features. Other photogrammetry software may include ADCIS Aphelion, Photomodeler, Photosculpt, Kinect Fusion, etc.

At step 310, machine tool compensation may occur so that the 2D/3D image will be matched and compared with a database of the component 102 image or plurality of images stored in the computing device 130. The database can contain component specification (dimensions, weight, surfaces (internal and/or external), geometries, etc.) for an original equipment manufacturer (OEM)'s component, such as a component from Caterpillar, of Peoria, Ill. or specification for a special order component or a modified OEM component. The database can be stored on computing device 130 that is located nearby or on another computing device remote from where the imaging and scanning take place. Once the image of the component 102 is matched and compared with the database component 102 images, the software can interact with a CNC controller program so that the program can change or create the machine tool's path to match the part orientation and feature irregularities. That is, the 2D/3D image of the component 102 is compared to the image database and the difference such as dimensions, surfaces, geometries are determined, the CNC controller will be changed so that the proper amount of excess material or burrs can be properly removed from the component 102 during the machining process. In another aspect of the disclosure, a user can also manually interact with the machining tool CNC controller to make the desired changes to the operation of the machining tool. Further, the CNC controller can include the database and software similar to the computing device.

Alternatively, after the machining step 310, the component 102 can be cleaned using various techniques such as liquid spray or light sanding or blasting to remove residual materials that may remain. At step 312, a second imaging similar to step 306 can be performed to verify that the component 102 is now within the desired specification range of the component 102 being machined. The acceptable specification range can be about +/−1 mm. If at step 312, the specification determined with the second imaging is within the acceptable specification range then the process can end. If not, the process can return step 310 for furthering machining of the component 102 until the specification of the component comes within the acceptable specification range. At step 314, the process ends.

By using the various aspects of the disclosure, issues typically associated with the machining of component 102 may be alleviated or eliminated. For example, break down of machining tools due to sudden excessive materials that were not expected to be part of the component as is the case in castings and weldments, can be reduced if the user is aware that a different, more robust machining tool is needed instead of a standard machining tool. Further, machine tool spindle damage may be reduced due to using the proper and adaptive machining tool with the proper spindle speed being used (due to excess material) instead of a standard machine tool with a standard spindle speed.

It is noted that components such as castings and welded structures often have excess or irregular shapes due to imperfections from the manufacturing process. These irregular features can cause tool breakage due to sudden increases in cutting forces. To mitigate this problem, the tool is moved in air without cutting which results in an increase in cycle time.

Metal components are often coupled together using many processes, such as welding, molding, casting, trimming, slitting or shearing in order to create pieces of specific shape and size. These processes often create ragged edges or protrusions. The raised particles and shavings that appear when metal blanks are machined are referred to as burrs, and the process by which they are removed is known as deburring. Various aspects of the disclosure can be used to dynamically adjust the machining cycle to have on machine deburring process instead of having to stop the machining process and switch to a dedicated deburring machining tool or stop to deburr later in the production process. This saves production time and costs associated with production of the component 102. Further, this also saves from unnecessarily using a deburring machine when it is not required in the machining process.

The process described above can be used with any component in any vehicle, device, apparatus and the like that can be manufactured or remanufactured. These components, such as truck frames, pump housings, track roller frames, wheeled loader upper, and the like, typically will be cast and then welded together. Further, the steps in the process do not all have to be performed or performed in any particular order. Some of the steps can be performed at the same time or be combined.

### INDUSTRIAL APPLICABILITY

A process of manufacturing or remanufacturing a component is provided that includes casting a component for a vehicle, such as an earthmoving machine. Once cast, the component can then be attached to a moveable table and images of the entire component can be captured by an imaging device or a plurality of imaging devices. After the images are captured, the images are stitched or manipulated to form a 2D/3D image of the component. The 2D/3D image or images can then be compared with a database of OEM components to determine the differences (dimensions, surface characteristics, etc.) between the 2D/3D image and an OEM component. Once the differences are determined between the 2D/3D image and the OEM specification/images, the machining process can be adjusted based on the determined differences. This allows for adjustment to the machining process so that machining cycle time is reduced and proper machining tools are efficiently utilized.

We claim:

1. A manufacturing system for a component, comprising:
a machining tool configured to machine a large cast or welded component;
an imaging device configured to travel on a carriage and capture a plurality of images of the component, wherein the carriage is configured to allow the imaging device to translate on a plurality of axis;
a component moving device configured to move the component along the plurality of axis; and
a computing device configured to store a software and a database of a plurality of images of an original equipment manufacturer's component, wherein the computing device utilizing the software to perform the steps of:
receiving the image captured by the imaging device;
stitching the plurality of images to form a 2D/3D image of the component;
comparing the 2D/3D image with the plurality of images of the original equipment manufacturer's component; and
adjusting an operating cycle of the machining tool based on the comparison.

2. The system of claim 1 further comprising the step of determining a difference between the 2D/3D image and the plurality of images of the original equipment manufacturer's component.

3. The system of claim 1, wherein the plurality of axis includes X, Y, Z, U, V, W, A, B and C axis.

4. The system of claim 2, wherein the differences between the 2D/3D image and the plurality of images of the original equipment manufacturer's component include dimensions, surfaces, or geometries.

5. The system of claim 1, wherein the imaging device and the component moving device move in relation to each other.

6. The system of claim 1, wherein the image device translates along the plurality of axis and the component moving device remains stationary.

7. The system of claim 1, further comprising the step of verifying if the component is within an acceptable specification range for that component.

8. The system of claim 1, wherein the plurality of images are captured within a planar location grid.

9. The system of claim 8, wherein the planar location grid includes a ZY axis plane grid and a ZX axis plane grid.

10. The system of claim 1, wherein the image device remains stationary and the component moving device translates along the plurality of axis.

11. A manufacturing system for a component, comprising:
a machining tool configured to machine a cast or welded component;
a plurality of imaging devices configured to travel on a plurality of carriages and to capture a plurality of images of the component, wherein the plurality of carriages are configured to allow the plurality of imaging devices to translate on a plurality of axis;
a component moving device configured to move the component along the plurality of axis; and
a computing device configured to store software and a database of plurality of images of an original equipment manufacturer's component, wherein the computing device utilizing the software to perform the steps of:
receiving the plurality of images captured by the plurality of imaging devices;
stitching the plurality of images to form a 2D/3D image of the component;
comparing the 2D/3D image with the plurality of images of an original equipment manufacturer's component;
determining a difference between the 2D/3D image and the plurality of images of the original equipment manufacturer's component; and
creating a new cycle or adjusting a preprogrammed operating cycle of the machining tool based on the determined difference.

12. The system of claim 11, wherein the computing device is remote from the machining tool.

13. The system of claim 11, wherein the plurality of axis include X, Y, Z and W axis.

14. The system of claim 12, wherein the difference between the 2D/3D image and the plurality of images of the original equipment manufacturer's component includes dimensions, surfaces, or geometries.

15. The system of claim 11, wherein the plurality of imaging devices and the component moving device move in relation to each other.

16. The system of claim 11, wherein the plurality of image devices translate along the plurality of axis and the component moving device remains stationary.

17. The system of claim 11, further comprising the step of verifying if the component is within the acceptable specification range for that original equipment manufacturer's component.

18. The system of claim 11, wherein the plurality of images are captured within a planar location grid.

19. The system of claim 18, wherein the planar location grid includes a ZY axis plane grid and a ZX axis plane grid.

20. The system of claim 11, wherein the machining tool includes a controller configured to perform the steps of the computing device.
